(19) United States
(12) Patent Application Publication
(10) Pub. No.: US 2008/0125889 A1
(43) Pub. Date: May 29, 2008

(54) METHOD AND SYSTEM FOR CUSTOMIZATION OF ENTERTAINMENT SELECTIONS IN RESPONSE TO USER FEEDBACK

(76) Inventors: William Edward Atherton, Hillsborough, NC (US); Daniel Otto Becker, Austin, TX (US); James Gordon McLean, Fuquay-Varina, NC (US); Aaron Eliahu Merkin, Holly Springs, NC (US); David B. Rhoades, Raleigh, NC (US)

Correspondence Address: IBM CORPORATION (SS/NC);c/o STREETS & STEELE, 13831 NORTHWEST FREEWAY, SUITE 355, HOUSTON, TX, 77040, US

(21) Appl. No.: 11/466,176

(22) Filed: Aug. 22, 2006

(51) Int. Cl. G06F 17/00

(52) U.S. Cl. 700/94

(57) ABSTRACT

A method, computer program product, and system for playing a series of discrete digital selections, such a MP3 files, from a selection database selected at least in part on user preference ratings, receiving user preference feedback for a particular selection while the particular selection is playing, and altering the user preference rating for the particular selection based upon the user preference feedback received. The user preference feedback may be provided in the form of a new user preference rating or an instruction to increment or decrement the current user preference rating. Alternatively, the user preference feedback may be determined by user interaction with standard controls, such as an increase in a user preference rating for a selection upon determining that a user has replayed the selection.

### BACKGROUND OF THE INVENTION

1. Field of the Invention

The present invention relates to music playback systems and methods. In particular, the invention relates to playing music selected on the basis of user preference.

2. Description of the Related Art

Computers and other digital devices are merging together with many forms of entertainment. As digital music formats increase, storage media capacity increases and compression techniques improve, music selections will become more and more portable in terms of digitally-stored files. An example of this increased portability is the exploding popularity of MP3 files that allow entire songs to be stored, traded, and played back digitally. Additionally, the direct digital transfer of music selections to listeners is increasing in popularity. The direction of these developments is towards random-access, via internet, satellite, or other technology, of nearly every music selection in existence. The problem, then, becomes accessing this huge database in a personalized, low-maintenance way.

Current systems for storage, organization or use of music selections (i.e., MusicMatch Jukebox or similar) allow users to rate selections on the basis of preference (typically by assigning a star rating). However, this is often inconvenient as users must be at their main repository and actively pull up selections to rate them rather than responding in a natural listening environment.

Many different types of multi-media devices support the aggregation of diparate, discrete content from one or more sources. Content could include graphical files, audio files, video files, etc. Often the device will support the categorization of the content. Some example categories are source, duration, genre, and artist. Generally, the device will contain content from a variety of categories.

Some existing devices support the playback of that content in a random order (usually denoted “shuffle”). When the user of the device utilizes the shuffle functionality of the device, the content will be served to them in random order. Unfortunately, the user of the device may not be in the mood for content from a particular category. However, it can be assumed that the content is desirable to them at some point in time because the content has been downloaded onto, or otherwise listed for use with, a device that they are using. The device generally will allow the user to skip over the individual selection of content, but there remains a chance that the user will be served content from the same category during the same session.

Ideally, a device would enable a user to enjoy the shuffle functionality of their device with the content tailored to a particular mood of the user. Known solutions to this problem include the manual creation of preferences and sorted playlists as detailed in U.S. Pat. No. 6,031,797 and U.S. Pat. No. 6,933,433.

U.S. Pat. No. 6,657,116 describes a system that selects music based on the preferences of a current listening group, such as two or more listeners. Each listener must provide their preferences for each album, song and artist so that the system can generate a music schedule that is acceptable to each listener in the current listening group.

However, there remains a need for a system that selects content for playback on the basis of current user listening preferences. It would be particularly desirable to have a system that would learn the user's preferences over a period of user interaction with the system during playback.

### SUMMARY OF THE INVENTION

The present invention provides a method comprising accessing a content database that stores a plurality of discrete digital selections; accessing a user preferences database that stores user preference ratings for one or more of the selections in the content database; playing a series of discrete digital selections from the content database selected at least in part on the user preference ratings; receiving user preference feedback for a particular selection while the particular selection is playing; and altering the user preference rating for the particular selection based upon the user preference feedback received. The invention also encompasses a computer program product including instructions embodied on a computer readable medium for collecting user preference ratings during playback. Furthermore, the invention encompasses a media playback system for shuffle playback considering user preference ratings, wherein the system comprises one or more processors coupled directly or indirectly to one or more memory devices, one or more input devices, and one or more output devices, wherein the one or more input devices are adapted for producing user preference signals and the one or more output devices are adapted for receiving selection playback signals, wherein the one or more memory devices store an application program having a logical structure to provide instructions to the one or more processors for carrying out the method.

In one embodiment, the method further comprises determining the probability or frequency that discrete digital selections will be subsequently played based upon altered user preference ratings. In another embodiment, the method further comprises receiving user preference feedback in the form of a new user preference rating. In yet another embodiment, the method further comprises receiving user preference feedback in the form of an instruction to increment or decrement the current user preference rating.

In a still further embodiment, the method further comprises detecting an extent of completion or repetition of a selection that is played, and applying the extent of completion or repetition as user preference feedback. Optionally, the user preference feedback is positive when discrete digital selections are played beyond a positive completion setpoint, positive when discrete digital selections are repeated, and negative when discrete digital selections are terminated short of a negative completion setpoint. This embodiment may also include allowing a user to enter a review mode wherein completion, incompletion and repetition of a selection are not applied as user preference feedback.

In yet another embodiment, the method may include detecting a playback parameter while a particular selection is played; and applying the playback parameter as the user preference feedback to alter the user preference for the particular selection, wherein the playback parameter is selected from volume, fast forward, reverse, skip, and combinations thereof.

In another embodiment, the method may include introducing new discrete digital selections into the database; and automatically storing an initial user preference rating in association with the new discrete digital selections. Optionally, the initial user preference rating is a temporary priority rating that causes the new discrete digital selections to be played once ahead of selections having other user preference ratings before being substituted with a default user preference rating.

In a further embodiment, the method may further comprise developing multiple sets of user preference ratings corresponding to one or more parameter selected from a listening entity, time of day, and mood, wherein user preference feedback obtained in association with one parameter does not directly affect the user preference ratings in another mode.

Another embodiment includes obtaining user preference feedback on a portable media player, and transferring the user preference feedback or updated user preference ratings to a central computer.

In yet another embodiment, the discrete digital content is stored on a local media player or a remote server that is accessible over a network.

In a further embodiment, the discrete digital selections played from the database are selected at least in part on the associated user preference ratings from two or more users.

A further embodiment includes increasing user preference ratings associated with discrete digital selections that have at least one attribute in common with a previously played discrete digital selection that received favorable user preference feedback. An additional embodiment includes decreasing user preference ratings associated with discrete digital selections that have at least one attribute in common with a previously played discrete digital selection that received unfavorable user preference feedback.

### BRIEF DESCRIPTION OF THE DRAWINGS

FIG. 1 is a schematic diagram of a Web application server in communication with a computer system through a network.

FIG. 2 is a computer system having various typical input and output devices.

FIG. 3 is a schematic diagram of a computer system having a browser and network access for interacting with the Web application server.

FIG. 4 is an exemplary portable media player.

FIG. 5 is a schematic diagram of portable media player having an exemplary interface for input of user preference feedback.

FIG. 6 is a schematic diagram of a database of a library of discrete digital selections.

FIG. 7 is a logic diagram of a first method for real time collection of user preferences.

FIG. 8 is a second, more specific method in accordance with the invention.

### DETAILED DESCRIPTION

The present invention provides a method and system that allows a user to rate music or other entertainment selections simply and interactively, and have these ratings reflected in future shuffle or semi-random playback sessions. In simplest terms, the ratings are a factor in the probability that a particular selection will play in the future. The invention includes simple interactive methods for a user to rate a particular selection in an intuitive and non-intrusive way. Preferably, the method includes a mechanism to automatically change user preference ratings based at least in part on user listening patterns, such as the completion or repetition of selections. The method may also include manually changing a user preference rating, either by directly rating (e.g., by pushing a button 1-10 to give an absolute rating) or incrementing/decrementing the existing rating (e.g., by pushing an increment button or decrement button).

The playback system should include one or more input device, such as a keyboard, keypad, standard playback controls, or special function keys, in order to allow the user to control the device as necessary. The one or more input device may be in one or more of various forms including, without limitation, keys, buttons, knobs, sliders, joysticks and touch pads. In one embodiment, the playback system may include only standard playback controls, such that the type of user feedback is limited to determination of the user's listening patterns with respect to each selection. For example, the repetition of extent of completion of a particular selection can be monitored by the system of the present invention even though the user input is limited to standard playback controls. In another embodiment, the playback system includes special function input devices, such as a set of buttons that allow the user to manually alter the rating of a particular selection. Most preferably, the special function input devices are provided along with a separate set of standard playback controls. It should be recognized that the number of functions or devices in a set of standard playback controls may itself vary. For example, a device might be suitable without fast forward control or other type of control that may be common on other devices. Additionally, individual physical controls may serve multiple functions based on a mode setting. For example, a button or scroll device that may serve to choose a selection in one mode may also be used to provide preference feedback in another mode.

In one embodiment, an initial rating may be assigned to every selection that is played, such as a numerical rating of “5” on a 10-point scale. The playback device might then include a simple set of buttons, such as a set of standard playback controls (i.e., play, skip, and replay) that serve to directly affect the current playback. The device may monitor the use of these controls to alter the user preferences. For example, skipping a portion of a selection would decrease the numerical rating. The device might even be programmed so that the amount or extent of the selection skipped would determine how many rating points were subtracted off of the previous rating for that selection. Similarly, replaying a selection would increase the numerical rating. The device might even be programmed to increase the rating by one point every time it is replayed within a given time frame.

In this same embodiment, the playback device might include a set of special function input devices, such as a set of buttons that allow the user to manually alter the rating of a particular selection. These buttons might include an “increase rating” button and a “decrease rating” button, where the user could add or subtract a point, respectively, from the previously stored user preference rating for the playing selection. Furthermore, these buttons might also include a “maximize” button or “minimize” button to give a selection the highest or lowest possible rating, respectively. Any number of buttons could be envisioned to add or subtract one, two, or any number of points to a stored rating. Furthermore, the set could include separate buttons for rating the playing selection, rating the artist of the playing selection, rating the album of the playing selection, rating the genre of the playing selection, or some combination thereof. Regardless of the number of buttons, the user begins to “teach” the system which selections he/she prefers. The system can then use the user preference ratings to manage a playback sequence.

It should be recognized that there are various methods possible for using the customized user preference ratings data to shape future play patterns. For example, a simple system may prepare a list by randomly ordering all selections, and then either maintaining or removing each selection from the list based on the current user preference rating for the respective selection. For instance, if a selection with a current rating R is pre-selected, an algorithm, such as P(accept)=0.1*R, may be used to determine whether the selection is accepted for play or not.

Many other methods are available for shaping future play patterns. In some embodiments, the future play patterns may include preparation of a playlist including some number of selections or some length of play time using current user preference ratings. This list may be played to completion before preparing the next playlist based on the user preference ratings available at that time. In alternative embodiments, the next song may be determined in real time and therefore may optionally consider even the latest user preference feedback. The present invention is not limited by the particular method of developing the play pattern or selection list, but rather is primarily directed to the method of collecting ongoing user preference ratings data during playback.

While many users would not desire to automatically hear a selection two consecutive times in a “shuffle” even if that selection had a maximum rating, a real time determination of the next selection to play would present the opportunity to utilize the rating of the currently playing selection to pick the next selection on the basis of the artist, genre, or other variable associated with the currently playing selection. For example, if selection A in genre X is given a maximum rating, then next selection might be intentionally chosen from genre X. Another effect of the maximum rating would preferably include more frequent playing of selection A.

In a further embodiment, the system may include automatic (predictive) inclusion or playing of a new selection based on a common characteristic between the new selection and a previously rated selection. These characteristics may include, without limitation, artist, genre, musical style or genre, instrumentation, pace, structure, length, or other definable attributes. Still further, when two or more playback systems or devices are in communication, a particular playback system may automatically (predictively) include a new selection based on a user preference rating for that new selection in the other playback system. Preferably, the new selection from the other playback system will be chosen based on a high user preference rating, such as a rating exceeding a user sharing setpoint, but also based on the new selection having some characteristic in common with highly rated selections or selections having recently increased ratings on the particular playback system. In a network environment, a user may identify which other playback systems they want their own playback system to communicate with and share ratings data with. Alternatively, the second playback system may be a central library of selections, such as iTunes (an Internet music store operated by Apple Computer Corporation). Where a purchase is involved, the new selection may be automatically placed on a suggested purchase list, rather than automatically purchased and downloaded.

It should also be recognized that new selections may be manually introduced by instructing the system to select or copy the selection. These new selections may come from any compatible source, such as the user's own existing collection of selections (perhaps from another medium) or through a subscription to a standard music “channel”. The sources and availability of selection is constantly changing and is not considered to be a limitation of the invention.

In yet another embodiment, a system may have the ability to store user preference ratings or changes to those ratings in a local storage medium and later transmit those ratings or changes to ratings to a central database. For example, if a particular selection is incremented in preference three times on a portable MP3 player, the next time that player is connected to another device, such as a PC, that new rating or change in rating information is tied back to the user preference rating database there. In this manner, the learning accomplished by the device, which is representative of the user's current preferences, can be shared with another device that most typically belongs to the same user.

The present invention may utilize weighted priority for playback during shuffle. Initially, all content is given the same weight and therefore the same chance of being played next. However, the invention implements a learning system such that when a user skips over a selection, other selections having the same or similar characteristics have their weighting reduced such that these other selections are less likely to be played. This weighted priority system has the effect of tailoring the playback in real time in response to users dynamic preferences such that selections similar to selections already played to completion are increasingly more likely to be played.

In one embodiment of a weighted priority system, the user preference rating for a particular selection may be the composite or sum of a title rating and one or more other ratings, such as an artist rating, genre rating and duration rating. Accordingly, ratings of certain selections may be interdependent upon the ratings of other selections having a similar characteristic. For example, if selection B by artist Y is given a minimum rating, then other selections C and D by the same artist Y will have a lower composite rating by virtue of the artist component of the sum being lower.

In a still further embodiment, the system may include concurrent development of multiple probability maps corresponding to various parameters, such as listener(s) present, time of day, etc.

The present invention may be implemented solely in a local user device (such as a portable MP3 player) or in some combination of a local device and a remote device or server (such as a website accessible over the Internet). In a local device embodiment, the local device includes one or more input devices and a readable medium for storage of the user preferences and the discrete digital selections. The local user device may be used as a standalone user device or in combination with other devices. Embodiments that combination a local device and a remote device will have the input device in the local device accessible to the user, but may store the user preferences database on the same or different device as the digital selections database. For example, a computer may provide an input device such as a mouse or keyboard. The computer may have a Web browser and a connection with an Internet service provider (ISP) for communication with a remote application server. The remote application server may include a website that provides the user with an account that allows access to a large database of selections. The website may provide streaming playback of selections to the user's computer for listening over the computer's speakers. As the user interacts with the Website's playback interface, an application program may begin learning the user's preference and populating a user preferences database, whether that user preferences database is stored on the user's local computer or on the remote Web server in association with the user's account.

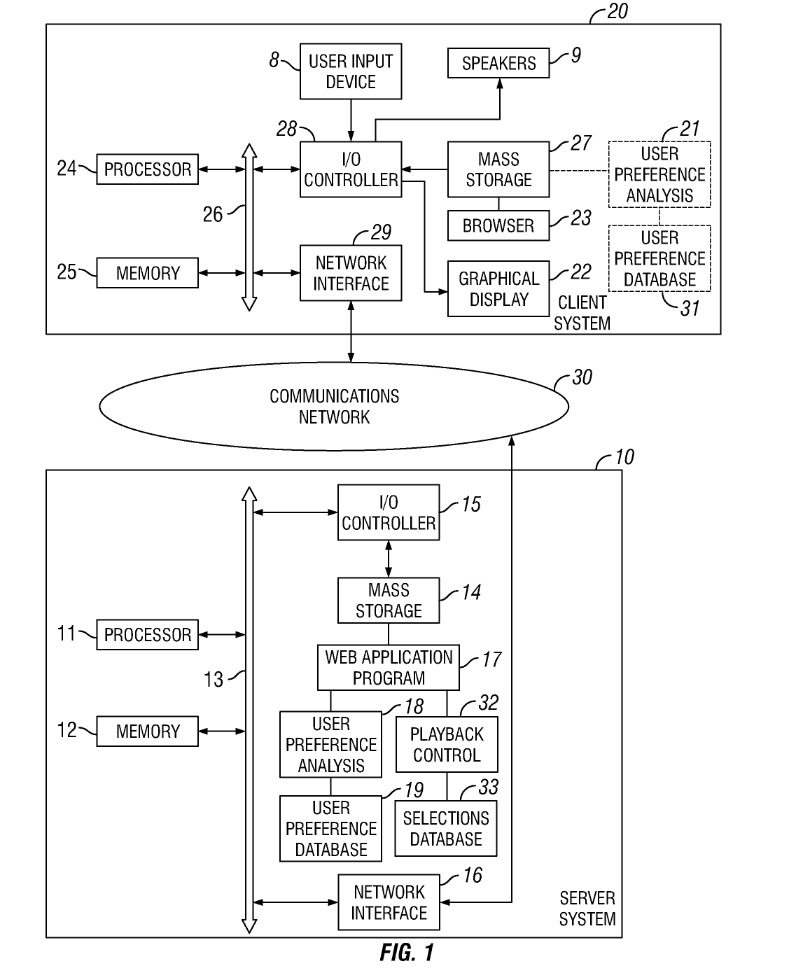

FIG. 1 is a schematic diagram of a Web application server system 10 in communication with an individual user's computer 20 through a network, such as the Internet 30. The user's computer 20 includes conventional components such as a processor 24, memory 25 (e.g. RAM), a bus 26 which couples the processor 24 and memory 25, a mass storage device 27 (e.g. a magnetic hard disk or an optical storage disk) coupled to the processor and memory through an I/O controller 28 and a network interface 29, such as a conventional modem. A user input device 8, such as a set of buttons or keyboard, and speakers 9 are also provided through the I/O controller. The Web application server system 10 also includes conventional components such as a processor 11, memory 12 (e.g. RAM), a bus 13 which couples the processor 11 and memory 12, a mass storage device 14 (e.g. a magnetic or optical disk) coupled to the processor 11 and memory 12 through an I/O controller 15 and a network interface 16, such as a conventional modem.

It should be appreciated that the present invention may be implemented in software that is stored as executable instructions on a computer readable medium on the Web application server 10, such as in mass storage device 14 or in memory 12. The Web application server system 10 is shown having a Web application program 17, a user preference analysis program 18, a user preference database 19, a playback control program of component 32, and a selections database 33 stored in mass storage device 14. The Web application server 10 is preferably also suitable for processing: (1) user account registration, (2) user account login and access to the digital selections database, (3) measuring user preferences with regard to the selections, (4) controlling playback of selections when a “shuffle” function is selected by the user, and (5) providing a user interface.

The communications network 30 is the medium used to provide communications links between the Web application server 10 and any number of various devices and computers (individually represented as computer 20). The communications network 30 may include permanent connections, such as wire or fiber optic cables, or temporary connections made through telephone or wireless communications. A registered user's computer and the Web application server may be represented by a variety of types of computing devices, such as mainframes, personal computers, personal digital assistants (PDAs), smart phones, etc. The server system may include additional servers, clients, routers and other devices not shown. In the example of FIG. 1, the network system 30 may include the Internet (a worldwide collection of networks and gateways that use the TCP/IP suite of protocols to communicate with one another). Of course, the Web application server 10 may also communicate over a number of different types of networks, such as, for example, an intranet, a local area network (LAN), or a wide area network (WAN).

The present invention can be implemented on a variety of hardware platforms and can be implemented in a variety of software environments. A typical operating system may be used to control program execution within the data processing system. Furthermore, although the preferred embodiment described below includes a “browser” 23 at the registered user's computer as the agent that exchanges data in the security protocols with the Web application server, the agent at the registered user's computer does not have to be a conventional browser, such as Netscape Navigator® or Microsoft Internet Explorer®. In order to optionally secure the information transmitted to and from the server, the user's computer may be capable of Public Key Infrastructure (PKI) technology exchanged in a security protocol such as the Secure Sockets Layer (SSL) version 3.0 and above.

In the embodiment of computer 20 shown in FIG. 1, the mass storage device 27 optionally includes an application program, referred to as user preference analysis program 21, and a user preferences database 31. The program 21 and database 31 are optional in the sense that they may either replace the same components on the Web server 10 or mirror the same components on the Web server so that computer 20 can maintain and execute the user preferences. One advantage of maintaining these files on the user's computer 20 is that it allows the user to apply their user preference ratings with an entirely different Web server or other service having a compatible selections database.

The Web application server 10 preferably operates a conventional server software program 21, such as International Business Machines' WebSphere®, for administering the participation-based Web application program. The server software includes application programs that enable the server 10 to manage user participation and apply predetermined rules or instructions to determine a participation level and provide corresponding benefits to a registered user.

The computer network 30 may be the Internet, an intranet, or other network. The server 10 may be a Web application server (WAS), a server application, a servlet process or the like. Optionally, the registered user's device 20 submits the required information to identify the registered user as being authorized to access the Web application. Registered user data may include a username and a password known by the Web application server 10. The application server 10 generates a graphical user interface that is displayed on a graphical display screen 22 by the browser 23 on the device 20. The Web application server 10 includes a user database 18 that contains records for each registered user that include the user identification, password used to access the Web application, and other user information. The participation data may be maintained in the same user database 18 or a separate participation database or log 19.

It should be recognized that the invention may take the form of an entirely hardware embodiment, an entirely software embodiment, or an embodiment containing both hardware and software elements. In particular embodiments, including those embodiments of methods, the invention may be implemented in software, which includes but is not limited to firmware, resident software and microcode.

Furthermore, the invention can take the form of a computer program product accessible from a computer-readable medium providing program code for use by or in connection with a computer or any instruction execution system. For the purposes of this description, a computer-usable or computer-readable medium can be any apparatus that can contain, store, communicate, propagate or transport the program for use by or in connection with the instruction execution system, apparatus or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), DVD-read only memory (DVD-ROM), and DVD-read/write (DVD-R/W).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

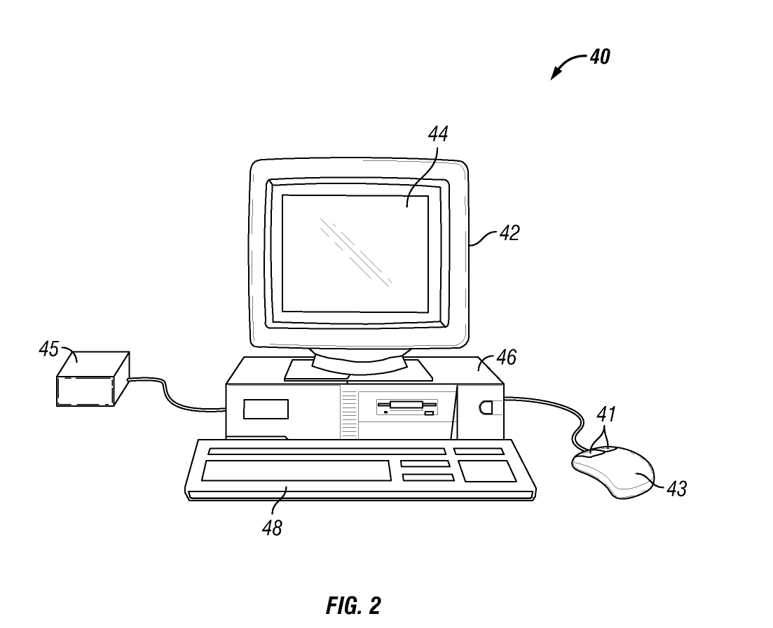

FIG. 2 is a computer system having various typical input and output devices. The computer system 40 is capable of running a browser. The computer system 40 includes a display device 42 (such as a monitor), a display screen 44, a cabinet 46 (which encloses components typically found in a computer, such as CPU, RAM, ROM, video card, hard drive, sound card, serial ports, etc.), a keyboard 48, a mouse 43 and a modem 45. The mouse 43 may have one or more buttons, such as buttons 41. The computer requires some type of communication device such as modem 45 that allows computer system 40 to be connected to the Internet. Other possible communication devices include Ethernet network cards.

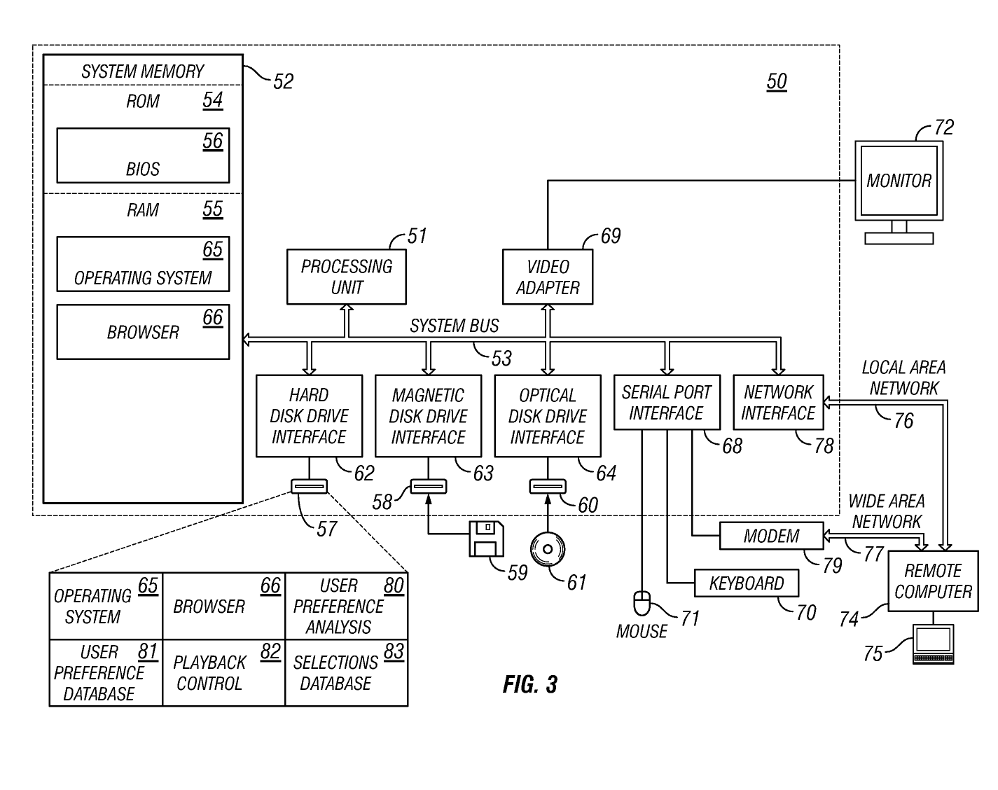

FIG. 3 is a schematic diagram of a computer system 50 that is capable of running a browser. The system 50 may be a general-purpose computing device in the form of a conventional personal computer 50. Generally, a personal computer 50 includes a processing unit 51, a system memory 52, and a system bus 53 that couples various system components including the system memory 52 to processing unit 51. System bus 53 may be any of several types of bus structures including a memory bus or memory controller, a peripheral bus, and a local bus using any of a variety of bus architectures. The system memory includes a read-only memory (ROM) 54 and random-access memory (RAM) 55. A basic input/output system (BIOS) 56, containing the basic routines that help to transfer information between elements within personal computer 50, such as during start-up, is stored in ROM 54.

Computer 50 further includes a hard disk drive 57 for reading from and writing to a hard disk 57, a magnetic disk drive 58 for reading from or writing to a removable magnetic disk 59, and an optical disk drive 60 for reading from or writing to a removable optical disk 61 such as a CD-ROM or other optical media. Hard disk drive 57, magnetic disk drive 58, and optical disk drive 60 are connected to system bus 53 by a hard disk drive interface 62, a magnetic disk drive interface 63, and an optical disk drive interface 64, respectively. Although the exemplary environment described herein employs hard disk 57, removable magnetic disk 59, and removable optical disk 61, it should be appreciated by those skilled in the art that other types of computer readable media which can store data that is accessible by a computer, such as magnetic cassettes, flash memory cards, digital video disks, Bernoulli cartridges, RAMs, ROMs, and the like, may also be used in the exemplary operating environment. The drives and their associated computer readable media provide nonvolatile storage of computer-executable instructions, data structures, program modules, and other data for computer 50. For example, the operating system 65 and application programs, such as a Web browser 66, user preferences analysis program 80, user preferences database 81, playback control 82, and selections database 83 may be stored in the hard disk 57 or in RAM 55 of the computer 50.

A user may enter commands and information into personal computer 50 through input devices, such as a keyboard 70 and a pointing device, such as a mouse 71. Other input devices (not shown) may include a microphone, joystick, game pad, satellite dish, scanner, or the like. These and other input devices are often connected to processing unit 51 through a serial port interface 68 that is coupled to the system bus 53, but input devices may be connected by other interfaces, such as a parallel port, game port, a universal serial bus (USB), or the like. A display device 72 may also be connected to system bus 53 via an interface, such as a video adapter 69. In addition to the monitor, personal computers typically include other peripheral output devices (not shown), such as speakers and printers.

The computer 50 may operate in a networked environment using logical connections to one or more remote computers 74. Remote computer 74 may be another personal computer, a server, a client, a router, a network PC, a peer device, a mainframe, a personal digital assistant, an Internet-connected mobile telephone or other common network node. While a remote computer 74 typically includes many or all of the elements described above relative to the computer 50, only a memory storage device 75 has been illustrated in the figure. The logical connections depicted in the figure include a local area network (LAN) 76 and a wide area network (WAN) 77. Such networking environments are commonplace in offices, enterprise-wide computer networks, intranets, and the Internet.

When used in a LAN networking environment, the computer 50 is often connected to the local area network 76 through a network interface or adapter 78. When used in a WAN networking environment, the computer 50 typically includes a modem 79 or other means for establishing high-speed communications over WAN 77, such as the Internet. A modem 79, which may be internal or external, is connected to system bus 53 via serial port interface 68. In a networked environment, program modules depicted relative to personal computer 50, or portions thereof, may be stored in the remote memory storage device 75. It will be appreciated that the network connections shown are exemplary and other means of establishing a communications link between the computers may be used. A number of program modules may be stored on hard disk 57, magnetic disk 59, optical disk 61, ROM 54, or RAM 55, including an operating system 65 and browser 66.

The devices shown in FIGS. 2-3 should not imply that the invention has architectural limitations. For example, those skilled in the art will appreciate that the present invention may be implemented in other computer system configurations, including hand-held devices, multiprocessor systems, microprocessor based or programmable consumer electronics, network personal computers, minicomputers, mainframe computers, and the like. The invention may also be practiced in distributed computing environments, where tasks are performed by remote processing devices that are linked through a communications network. In a distributed computing environment, program modules may be located in both local and remote memory storage devices.

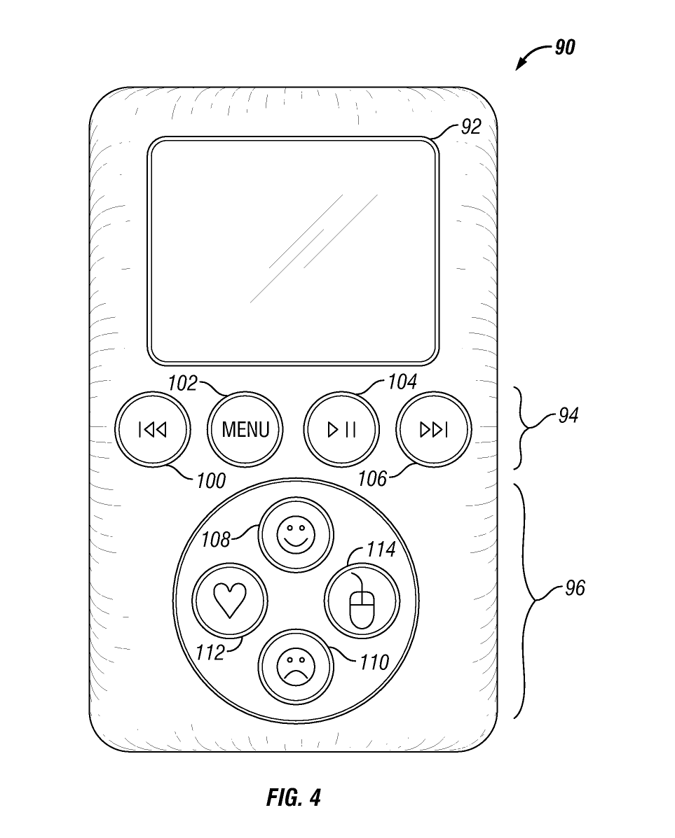

FIG. 4 is an exemplary portable media player or playback system 90 having a display screen 92, a set of standard control buttons 94, and a set of special function buttons 96 for providing direct manual user preference feedback to the system. While embodiments may vary the number and type of buttons provided, as discussed above, the system 90 provides four standard control buttons and four special function buttons. The standard controls include a dual purpose rewind/replay button 100 (tap to replay, hold to rewind), menu button 102, play/pause button 104 (toggle between these functions), and forward/skip button 106 (tap to skip, hold to forward).

The portable media player 90 also has an exemplary interface including special function buttons 96 for input of user preference feedback. Button 108, shown with a happy face icon, increments the rating for the current selection by one point so that the selection will be played more frequently. The increment button may be pressed repeatedly in order to increment the rating more than one point or step during a single playback. Button 110, shown with a sad face icon, decrements the rating for the current selection by one point so that the selection will be played less frequently. The decrement button may be pressed repeatedly in order to decrement the rating more than one step during a single playback. Button 112, shown as a heart-shaped “love” icon, maximizes (in our example, sets to “10”) the rating for the current selection so that the selection will be played as frequently as the playback selection control allows. Button 114, shown as a trash can icon, automatically sets the rating for the current selection to the lowest possible, or “never play”, rating (in our example, “0”). These and other buttons may be conveniently included on a remote control or added to a programmable remote control. In an advanced implementation, the type and number of buttons may allow the user to directly input a new rating for the current selection, such as by using a numeric keypad already on the remote or specially added to an equipped device. The examples given here should not imply that the invention is limited to the specific nature of the icons or controls described.

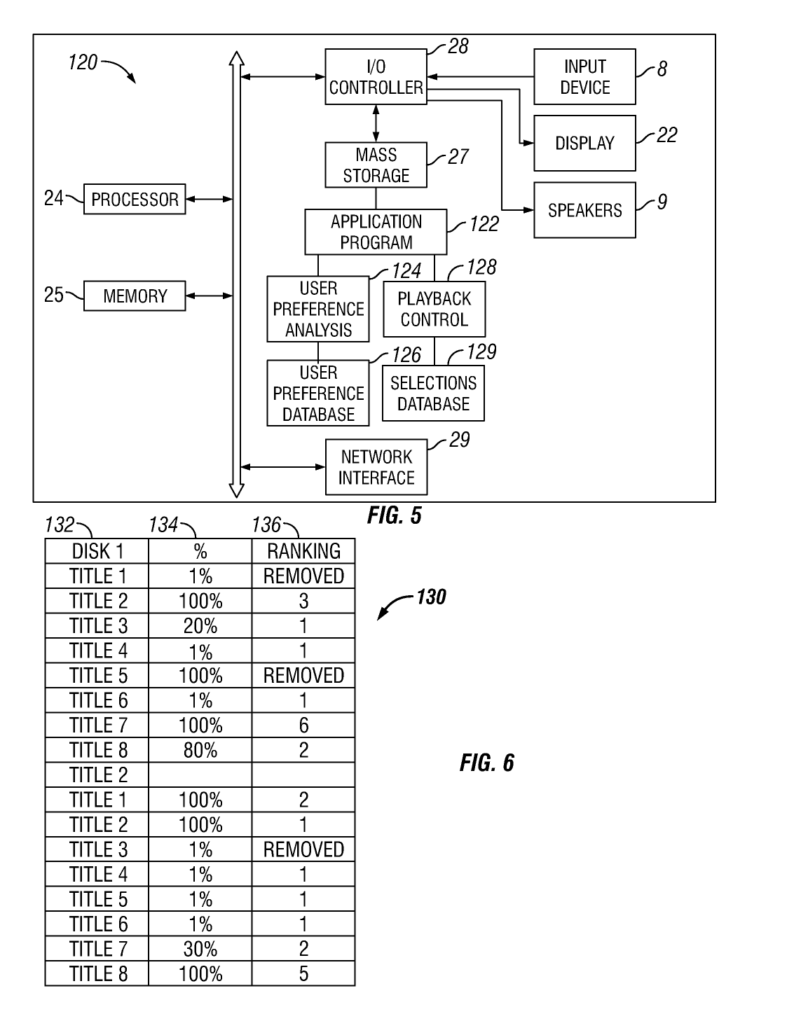

FIG. 5 is a schematic diagram of a media player 120 that may be implemented consistent with the configuration of media player 90 of FIG. 4 and is substantially consistent with the diagram of computer 20 in FIG. 1. Like components are referred to by like reference numbers and a full discussion of the components is not repeated here. However, the mass storage device 27 stores an application program 122 that includes or control various components, including user preference analysis 124, user preference database 126, playback control program 128, and the selections database 129. As shown, the media player 120 is capable of stand alone operation consistent with the present invention.

FIG. 6 is a schematic diagram of a database 130 or library of discrete digital selections. The database is illustrated as a table of information regarding the content from two compact disks (CDs) containing multiple selection titles that could be any media type, such as music or video. Each row of the table is a record having multiple fields. Each record is shown to contain a title field in column 132. Column 134 contains fields that store the average completion percentage for each selection title when the selection is played. Column 136 provides a rating field for each selection record, indicating the current user preference rating for the selection title in the same record (row). In this example, the rating may include a “removed” marker indicating that the selection is not to be played regardless of the associated completion percentage. The “removed” marker may be recorder as the result of pushing the trash can button 114 of the media player 90 in FIG. 4. During a random or shuffle playback, the selections that are not marked as “removed” may be played in accordance with any possible set of rules, algorithms, or probability maps. Optionally, the “removed” selections might remain accessible for manual playback when the shuffle feature is not being used.

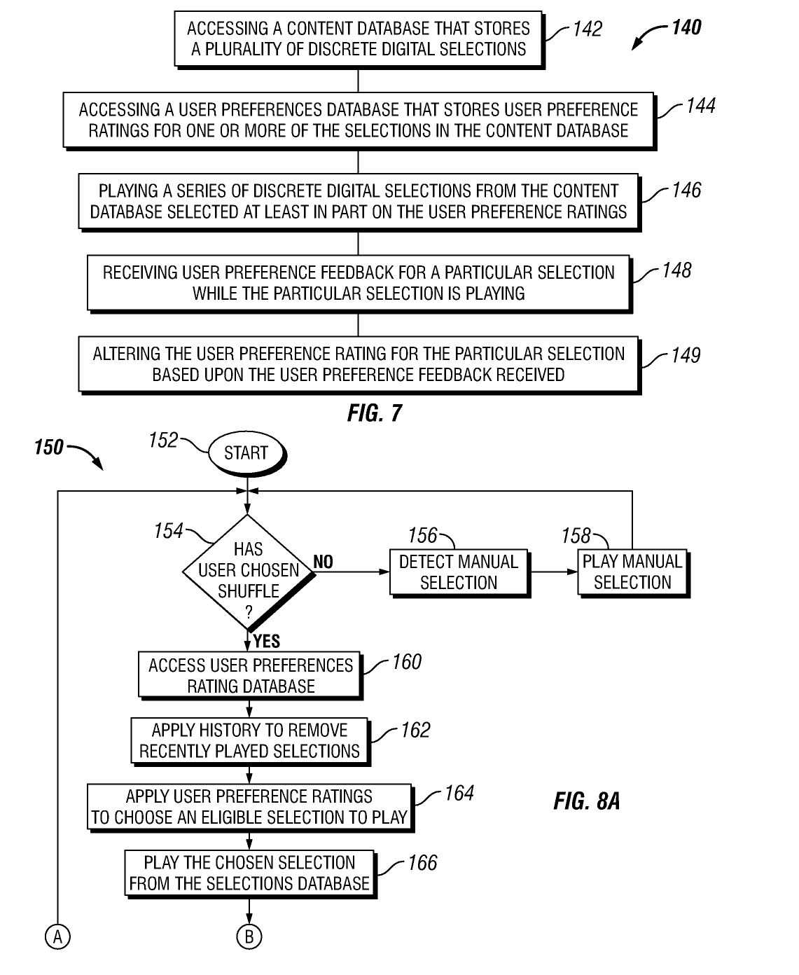

FIG. 7 is a logic diagram of a method for real time collection of user preferences. The method 140 includes the step 142 of accessing a content database that stores a plurality of discrete digital selections. In step 144, a playback system accesses a user preferences database that stores user preference ratings for one or more of the selections in the content database. In step 146, a series of discrete digital selections are played from the content database selected at least in part on the user preference ratings. User preference feedback is received, in step 148, for a particular selection while the particular selection is playing. The user preference rating for the particular selection is altered, in step 149, based upon the user preference feedback received. This method may be repeated as desired.

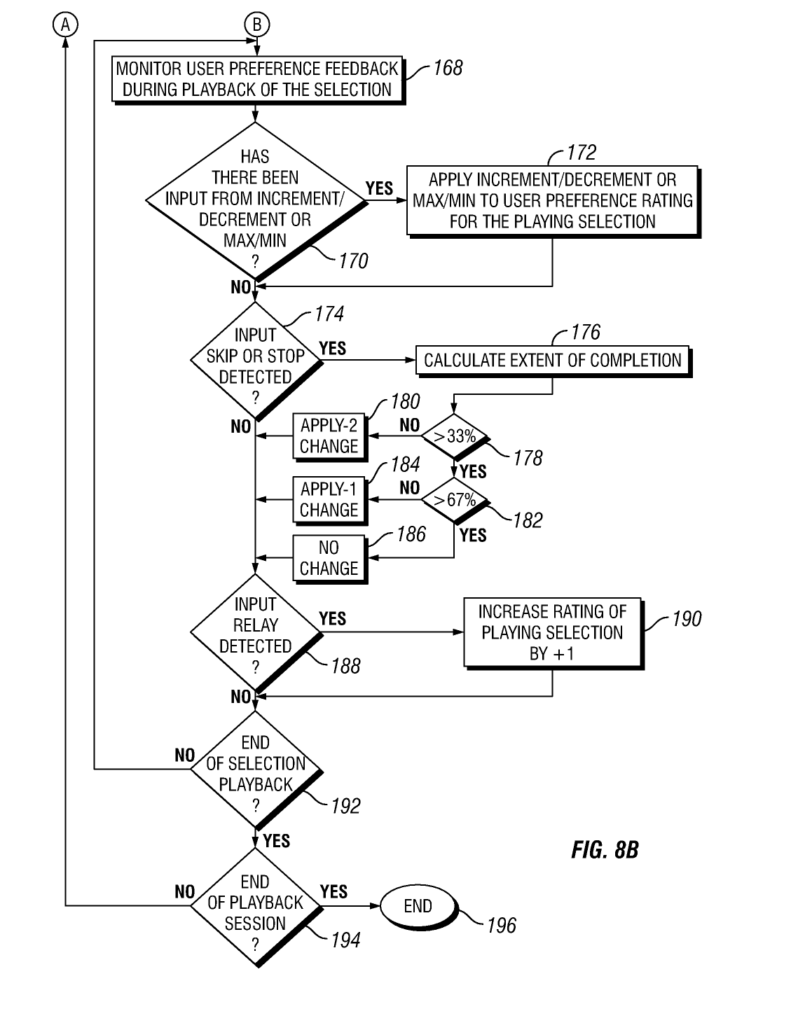

FIG. 8 is a second, more specific implementation of a method in accordance with the invention. The method 150 starts and step 152, presumable at the moment the playback system is powered on and the application program is loaded into memory. In step 154, the system determines whether the user has chosen a “shuffle” playback mode. If not, then a manual selection or “review mode” is detected in step 156, followed by playback of the manual selection in step 158, before returning to step 154. However, if the shuffle mode has been chosen, the method continues to step 160 where the system accesses the user preferences rating database.

Step 162 applies a playback history log to remove recently played selections from consideration as the next selection to be played. Optionally, the user may setup the system to delay repeat of a selection for a defined time period or a defined number of selections during a single playback session. User preference ratings are then applied in step 164 in order to choose an eligible selection to play. In step 166, the chosen selection from the selections database is played.

During playback of the selection, the system monitors for user preference feedback, as indicated in step 168. When input has been detected from an increment rating button, decrement rating button, maximum rating button, or minimum rating button in step 170, then the user preference rating for the playing selection is changed accordingly in step 172. Similarly, when input has been detected from a skip button or a stop button in step 174, then the extent of completion is calculated or determine in step 176. As shown, if the completion is not greater than a first set point, such as 33%, in step 178, then the user preference rating is reduced by two points in step 180. If the completion is greater than the first set point, but not greater than a second set point, such as 67%, in step 182, then the user preference rating is reduced by one point in step 184. If the completion is greater than the second set point, then step 186 makes no change to the rating of the skipped or stopped selection. Finally, if input has been detected from a replay button in step 188, then the user preference rating for the playing/replaying selection is increased by one point in step 190.

If it is then determined in step 192 that the selection playback has not ended (i.e., the selection is still playing), then the method returns to step 168 to monitor for additional user feedback. However, if playback of the selection has ended, then the method continues to step 194 in order to determine whether the playback session has ended (i.e., the user has turned off power or paused longer than a timeout period). If the playback session has not ended, then the method returns to step 154 to determine if the shuffle function is still in use. At the end of the playback session, the method ends at step 196.

In a still further embodiment, the invention may receive and store user preference ratings from two or more individual users. The playback control may consider both sets of ratings or otherwise combine the ratings so that the playback reflects the combined preferences of a current listening entity. This consideration of multiple ratings may include adding or removing the ratings of individual users so that the playback reflects a combined rating of a current listening entity, for example to resolve a “removed” rating from one user and a “loves” rating from another user.

The terms “comprising,” “including,” and “having,” as used in the claims and specification herein, shall be considered as indicating an open group that may include other elements not specified. The term “consisting essentially of,” as used in the claims and specification herein, shall be considered as indicating a partially open group that may include other elements not specified, so long as those other elements do not materially alter the basic and novel characteristics of the claimed invention. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

It will be understood from the foregoing description that various modifications and changes may be made in the preferred embodiment of the present invention without departing from its true spirit. It is intended that this description is for purposes of illustration only and should not be construed in a limiting sense. The scope of this invention should be limited only by the language of the following claims.

What is claimed is:

1. A method, comprising:
accessing a content database that stores a plurality of discrete digital selections;
accessing a user preferences database that stores user preference ratings for one or more of the selections in the content database;
playing a series of discrete digital selections from the content database selected at least in part on the user preference ratings;
receiving user preference feedback for a particular selection while the particular selection is playing; and
altering the user preference rating for the particular selection based upon the user preference feedback received.

2. The method of claim 1, further comprising:
determining the probability or frequency that discrete digital selections will be subsequently played based upon altered user preference ratings.

3. The method of claim 1, further comprising:
receiving user preference feedback in the form of a new user preference rating.

4. The method of claim 1, further comprising:
receiving user preference feedback in the form of an instruction to increment or decrement the current user preference rating.

5. The method of claim 1, further comprising:
detecting an extent of completion or repetition of a selection that is played; and
applying the extent of completion or repetition as user preference feedback.

6. The method of claim 5, wherein the user preference feedback is positive when discrete digital selections are played beyond a positive completion setpoint, positive when discrete digital selections are repeated, and negative when discrete digital selections are terminated short of a negative completion setpoint.

7. The method of claim 5, further comprising:
allowing a user to enter a review mode wherein completion, incompletion and repetition of a selection are not applied as user preference feedback.

8. The method of claim 1, further comprising:
detecting a playback parameter while a particular selection is played; and
applying the playback parameter as the user preference feedback to alter the user preference for the particular selection, wherein the playback parameter is selected from volume, fast forward, reverse, skip, and combinations thereof.

9. The method of claim 1, further comprising:
introducing new discrete digital selections into the database; and
automatically storing an initial user preference rating in association with the new discrete digital selections.

10. The method of claim 1, wherein the initial user preference rating is a temporary priority rating that causes the new discrete digital selections to be played once ahead of selections having other user preference ratings before being substituted with a default user preference rating.

11. The method of claim 1, further comprising:
developing multiple sets of user preference ratings corresponding to one or more parameter selected from a listening entity, time of day, and mood, wherein user preference feedback obtained in association with one parameter does not directly affect the user preference ratings in another mode.

12. The method of claim 1, further comprising:
obtaining user preference feedback on a portable media player, and
transferring the user preference feedback or updated user preference ratings to a central computer.

13. The method of claim 1, wherein the discrete digital content is stored on a local media player or a remote server that is accessible over a network.

14. The method of claim 1, wherein the discrete digital selections played from the database are selected at least in part on the associated user preference ratings from two or more users.

15. The method of claim 1, further comprising:
increasing user preference ratings associated with discrete digital selections that have at least one attribute in common with a previously played discrete digital selection that received favorable user preference feedback.

16. The method of claim 1, further comprising:
decreasing user preference ratings associated with discrete digital selections that have at least one attribute in common with a previously played discrete digital selection that received unfavorable user preference feedback.

17. A computer program product including instructions embodied on a computer readable medium for collecting user preference ratings during playback, the instructions comprising:
instructions for accessing a content database that stores a plurality of discrete digital selections;
instructions for accessing a user preferences database that stores user preference ratings for one or more of the selections in the content database;
instructions for playing a series of discrete digital selections from the content database selected at least in part on the user preference ratings;
instructions for receiving user preference feedback for a particular selection while the particular selection is playing; and
instructions for altering the user preference rating for the particular selection based upon the user preference feedback received.

18. The computer program product of claim 17, further comprising:
instructions for receiving user preference feedback in the form of a new user preference rating.

19. The computer program product of claim 17, further comprising:
instructions for receiving user preference feedback in the form of an instruction to increment or decrement the current user preference rating.

20. A media playback system for shuffle playback considering user preference ratings, the system comprising:
one or more processors coupled directly or indirectly to one or more memory devices, one or more input devices, and one or more output devices, wherein the one or more input devices are adapted for producing user preference signals and the one or more output devices are adapted for receiving selection playback signals; and
an application program stored in the one or more memory devices, the application program having a logical structure to provide instructions to the one or more processors for accessing a content database that stores a plurality of discrete digital selections, accessing a user preferences database that stores user preference ratings for one or more of the selections in the content database, playing a series of discrete digital selections from the content database selected at least in part on the user preference ratings, receiving user preference feedback for a particular selection while the particular selection is playing, and altering the user preference rating for the particular selection based upon the user preference feedback received.
